(19) United States
(12) Patent Application Publication
(10) Pub. No.: US 2026/0113823 A1
(43) Pub. Date: Apr. 23, 2026

(54) CONSTANT CURRENT DRIVING CIRCUIT, CIRCUIT INPUT POWER CALCULATION METHOD, AND LAMP

(71) Applicants: SUZHOU OPPLE LIGHTING CO., LTD., Suzhou City, Jiangsu (CN); OPPLE LIGHTING CO., LTD., Shanghai (CN)

(72) Inventor: Xianjiang DIAO, Suzhou City, Jiangsu (CN)

(73) Assignees: SUZHOU OPPLE LIGHTING CO., LTD., Suzhou City, Jiangsu (CN); OPPLE LIGHTING CO., LTD., Shanghai (CN)

(21) Appl. No.: 19/425,579

(22) Filed: Dec. 18, 2025

Related U.S. Application Data
(63) Continuation of application No. PCT/CN2024/100280, filed on Jun. 20, 2024.

(30) Foreign Application Priority Data
Jun. 21, 2023 (CN) 202310746309.4
Jun. 21, 2023 (CN) 202321611356.X

(51) Int. Cl. H05B 45/345; H05B 45/24; H05B 45/325; H05B 45/375; H05B 45/385

(52) U.S. Cl. CPC H05B 45/345; H05B 45/24; H05B 45/325; H05B 45/375; H05B 45/385

(57) ABSTRACT

The present disclosure provides a constant current driving circuit, a circuit input power calculation method, and a lamp. The constant current driving circuit includes: a constant voltage module, configured to convert an external alternating current into a direct current with a constant voltage, where a first resistor is connected to a negative output terminal of the constant voltage module; a constant current module, connected to the constant voltage module and configured to convert the direct current with the constant voltage into a direct current with a constant current; an operational amplifier detection module, where input terminals of the operational amplifier detection module are connected to both ends of the first resistor and configured to detect a voltage of the first resistor; and a control module.

### CROSS-REFERENCE TO RELATED DISCLOSURES

This disclosure is based upon and claims the priority of PCT patent disclosure No.

PCT/CN2024/100280 filed on Jun. 20, 2024, which claims priority to the Chinese patent disclosure No. 202310746309.4 filed on Jun. 21, 2023 and the Chinese patent disclosure No. 202321611356.X filed on Jun. 21, 2023, the entire contents of which are hereby incorporated by reference herein for all purposes.

### TECHNICAL FIELD

The present disclosure relates to the field of lighting, in particular to a constant current driving circuit, a circuit input power calculation method, and a lamp.

### BACKGROUND

With the improvement of living standards, LED lighting is increasingly applied in many scenarios, among which intelligent lighting is also more and more widely used in people's daily lives. People meet more usage needs by controlling LED lamps.

### SUMMARY

The present disclosure provides a constant current driving circuit and a lamp.

The present disclosure provides a constant current driving circuit which includes:
a constant voltage module that may be configured to convert an external alternating current into a direct current with a constant voltage, where a first resistor may be connected to a negative output terminal of the constant voltage module;
a constant current module that may be connected to the constant voltage module and configured to convert the direct current with the constant voltage into a direct current with a constant current;
an operational amplifier detection module, where input terminals of the operational amplifier detection module may be connected to both ends of the first resistor and configured to detect a voltage of the first resistor; and
a control module, where the control module may be connected to a positive output terminal of the constant voltage module to detect an output voltage of the constant voltage module, the control module may be further connected to the operational amplifier detection module, and an output terminal of the control module may be connected to the constant current module and configured to output a signal to the constant current module.

The operational amplifier detection module may amplify the detected voltage of the first resistor and outputs the amplified detected voltage to the control module, and the control module may calculate an input power of the constant current driving circuit according to the detected output voltage of the constant voltage module and the amplified detected voltage of the first resistor.

The present disclosure provides a circuit input power calculation method for calculating the power of the above-mentioned constant current driving circuit, which may include:
detecting and amplifying the voltage of the first resistor, and outputs the amplified voltage to the control module by the operational amplifier detection module;
converting the amplified voltage of the first resistor which is received to obtain an output current of the constant current driving circuit by the control module, and at the same time detecting the output voltage of the constant voltage module by the control module;
calculating an output power of the constant voltage module according to the output current of the constant current driving circuit and the output voltage of the constant voltage module by the control module; and calculating the input power of the constant current driving circuit according to the output power of the constant voltage module by the control module.

The present disclosure further provide a lamp including the above-mentioned constant current driving circuit.

The lamp may include two light source modules with different color temperatures, the light source modules are connected to the constant current driving circuit by four wires, LEDW+, LEDW−, LEDC+, and LEDC−, where LEDW+and LEDC+are common anodes on the constant current driving circuit and directly connected to the output terminal of the constant voltage module.

It is to be understood that both the foregoing general description and the following detailed description are exemplary and explanatory only and are not restrictive of the present disclosure.

### BRIEF DESCRIPTION OF DRAWINGS

FIG. 1 is a schematic block diagram of a constant current driving circuit according to an example of the present disclosure; and

FIG. 2 is a circuit diagram of a constant current driving circuit according to an example of the present disclosure.

### DETAILED DESCRIPTION

The reference numbers used in this disclosure may include:

Reference signs: 100—Constant current driving circuit; 10—Constant voltage module, 20—Constant current module, 30—Control module, 40—Operational amplifier detection module, 50—Light source module.

It should be noted that in order to avoid obscuring the present disclosure due to unnecessary details, only the structures and/or processing steps closely related to the solution of the present disclosure are shown in the accompanying drawings, and other details irrelevant to the present disclosure are omitted.

In addition, it should be noted that the terms “including”, “comprising” or any other variants thereof are intended to cover non-exclusive inclusion, so that a process, method, article or device including a series of elements not only includes those elements but also includes other elements not explicitly listed, or elements inherent to such a process, method, article or device.

Intelligent lighting may conveniently adjust the color temperature, current, and the like of LED lamps through various control methods, such as Bluetooth, WIFI, PLC, DALI, and 0-10V, to meet people's diverse usage scenarios and needs. In intelligent lighting, communication with the outside is generally carried out through communication modules (Bluetooth, WIFI, PLC, DALI, 0-10V, etc.), and external control information is transmitted to the MCU. The MCU then converts the transmitted control information into PWM signals to control the working state of the driver. Under different PWM signals, the output current is different, and the LED voltage is also different, which makes the detection of input power relatively complex and often requires increasing more costs.

In view of this, it is indeed necessary to provide a constant current driving circuit, a circuit input power calculation method, and a lamp to solve the above problems.

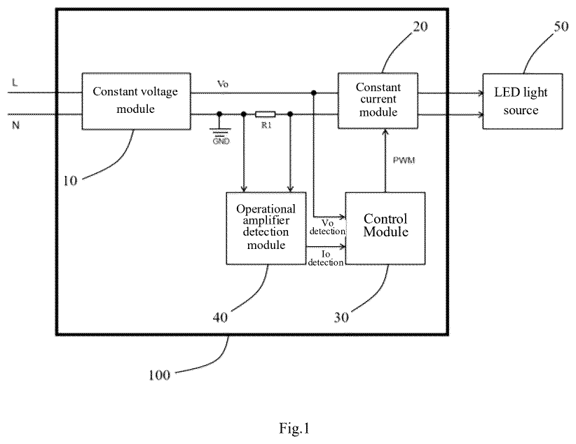

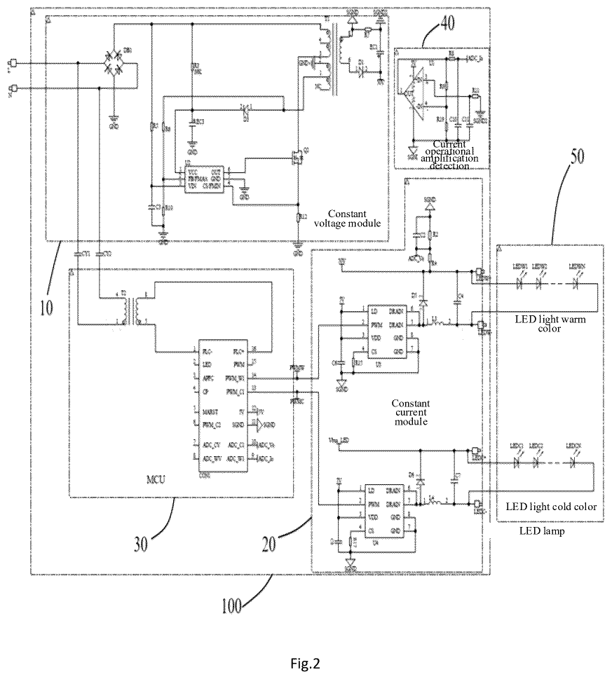

Please refer to FIGS. 1 and 2, which illustrates the constant current driving circuit 100 of the present disclosure, including:
a constant voltage module 10, configured to convert an external alternating current into a direct current with a constant voltage, a first resistor R1 being connected to a negative output terminal of the constant voltage module 10;
a constant current module 20, connected to the constant voltage module 10 and configured to convert the direct current with the constant voltage into a direct current with a constant current;
an operational amplifier detection module 40, input terminals of the operational amplifier detection module 40 being connected to both ends of the first resistor R1 and operational amplifier detection module 40 being configured to detect a voltage of the first resistor R1;
a control module 30, connected to a positive output terminal of the constant voltage module 10 to detect the output voltage of the constant voltage module 10, the control module 30 being further connected to the operational amplifier detection module 40, an output terminal of the control module 30 being connected to the constant current module 20, and the control module 30 being configured to output signals to the constant current module 20.

The operational amplifier detection module 40 amplifies the detected voltage of the first resistor R1 by a preset magnification and outputs it to the control module 30. The control module 30 calculates the input power Pi of the constant current driving circuit 100 according to the detected output voltage Vo of the constant voltage module 10 and the voltage Vr of the first resistor R1.

The constant current driving circuit 100 of the present disclosure can accurately detect the voltage Vr across the first resistor R1 connected to the output terminal of the constant voltage module 10 and transmit it to the control module 30 by the operational amplifier detection module 40 which is provided, and at the same time, detects the output voltage Vo of the constant voltage module 10 by the control module 30. Based on the above two values, the control module 30 can calculate the input power Pi of the constant current driving circuit 100.

In some examples, the constant current module 20 includes two voltage dividing resistors connected in series to the output terminal of the constant voltage module 10. An analog voltage is obtained after voltage division by the two voltage dividing resistors and transmitted to the control module 30, which converts the analog voltage to obtain the output voltage Vo of the constant voltage module 10. The control module 30 includes an ADC for converting analog signals.

The constant current module 20 includes a warm light constant current module and a cold light constant current module connected in parallel, which are configured to supply power to the corresponding warm light LED load and cold light LED load respectively.

Preferably, the control module 30 outputs two channels of PWM signals, the control module 30 outputs a warm light PWM signal to the warm light constant current module and the control module 30 outputs a cold light PWM signal to the cold light constant current module. In other examples, for different color temperatures, single or multiple outputs can also be used, which is not limited in the present disclosure.

The operational amplifier detection module 40 includes an operational amplifier chip, an eleventh resistor R11, and an eighth resistor R8. One end of the eleventh resistor R11 is connected to the first resistor R1, the other end of the eleventh resistor R1 is connected to the input terminal of the operational amplifier chip U1, and the output terminal of the operational amplifier chip U1 outputs a current to the control module 30 by the eighth resistor R8. The operational amplifier chip U1 and its surrounding resistors form a non-inverting operational amplifier, which can amplify the input signal by 1+R8/R11 times in the same direction. The eleventh resistor R11 is connected to the first resistor R1, and the first resistor R1 is connected to the GND terminal of the constant voltage module 10. When the current flows through the first resistor R1, a voltage difference is generated. The non-inverting operational amplifier amplifies this voltage difference and provides it to the control module 30. The control module 30 performs ADC sampling on the analog signal to obtain a voltage, and then divides the voltage by the magnification of the non-inverting operational amplifier and a resistance value of the first resistor R1 to obtain the output current Io of the constant voltage module 10. Thus, the output power of the constant voltage module 10 is obtained as Po=Io*Vo.

The control module 30 is an MCU controller, a flyback isolation architecture is used in the constant voltage module 10, and a Buck constant current architecture is used in the constant current module 20. In other examples, the constant voltage module 10 can be other power supply architectures or non-isolated architectures provided that it can generate a fixed voltage; the constant current module 20 can also be other power supply architectures, such as Boost and Buck-Boost, provided that it is a constant current architecture with PWM dimming function; the control module 30 can also be other types of controllers, which is not limited in the present disclosure.

The present disclosure also provides a circuit input power calculation method for calculating the power of the above-mentioned constant current driving circuit 100, including the following steps:
Step S1: The operational amplifier detection module 40 detects the voltage Vr of the first resistor R1, amplifies it by n times, and outputs it to the control module 30;
Step S2: The control module 30 converts the received voltage of the first resistor R1 to obtain the output current Io of the constant current driving circuit 100. The current received by the control module 30 can be obtained by the formula I=Vr*n/R1, and then the output current Io of the constant current driving circuit 100 is obtained by dividing by the magnification n. At the same time, the control module 30 detects the output voltage Vo of the constant voltage module 10;
Step S3: The control module 30 calculates the output power Po of the constant voltage module 10 according to the output current Io of the constant current driving circuit 100 and the output voltage Vo of the constant voltage module 10, with the calculation formula Po=Io*Vo;
Step S4: The control module 30 calculates the input power of the constant voltage module 10 according to the output power of the constant voltage module 10, with the calculation formula Pi=Po/η, where η represents the efficiency of the constant voltage module 10.

A data table is stored in the MCU controller, and the MCU controller determines the efficiency value η of the constant voltage module 10 corresponding to the actual duty cycle by looking up the table.

Since the efficiency of the constant current driving circuit 100 has little difference after component type selection, x test points (usually 10 points, i.e., one point for every 10% duty cycle) are taken for the duty cycle from 1% to 100%. For each point, the efficiency of multiple test constant current driving circuits 100 under the corresponding duty cycle is measured, and then the average value is taken. Thus, an efficiency values η corresponding to x duty cycle points are obtained and burned into the MCU. The MCU calculates the current input power Pi by dividing the sampled and calculated output power Po of the constant voltage module 10 by the corresponding efficiency value η according to the current PWM duty cycle D.

The present disclosure further provides a lamp including the above-mentioned constant current driving circuit 100.

The lamp includes two light source modules 50 with different color temperatures. The light source modules 50 are connected to the constant current driving circuit 100 by four wires, LEDW+, LEDW−, LEDC+, and LEDC−. LEDW+ and LEDC+ are common anodes on the constant current driving circuit 100, and directly connected to the output terminal of the constant voltage module 10.

The following is the disclosure of the constant current driving circuit 100 of the present disclosure in an intelligent constant current driver with 2-channel PWM dimming for constant current output. The constant current driving circuit 100 includes a constant voltage module 10, an MCU, and a constant current module 20. The constant current module 20 is an independent 2-channel step-down BUCK circuit, and the output current can be adjusted by the PWM signal of the MCU.

The MCU can output two channels of PWM signals. PWMW and PWMC, which are respectively connected to the dimming PWM pins of the two channels of dimming BUCK circuits. The MCU further has other functions on this intelligent driver, which are not described in this example.

The LED lamp light source includes two light source modules 50 with different color temperatures, which are respectively connected to the two output channels of the driver. One light source module 50 is an LED string with a color temperature of 2700K, and the other light source module 50 is an LED string with a color temperature of 6500K. Mixed different color temperatures and brightness can be obtained by different currents. The LED light source module 50 is connected to the driver by four wires, LEDW+, LEDW−, LEDC+, and LEDC−. LEDW+ and LEDC+ of these four wires are common anodes on the constant current driving circuit 100, that is, they are in a short-circuited state on the constant current driving circuit 100 and directly connected to the output terminal of the constant voltage module 10,

The function of the constant voltage module 10 is to convert the grid voltage into a fixed output voltage. This module is not limited to the architecture. In this example, it is a flyback isolation architecture, and can also be other power supply architectures or non-isolated architectures, provided that it can generate a fixed voltage. The output is marked as 50V in this example. In other examples, this voltage can be any suitable voltage according to actual conditions, which is not limited in the present disclosure.

In this example, the constant current module 20 is a Buck constant current architecture, and can also be other power supply architectures such as, Boost and Buck-Boost, provided that it is a constant current architecture with PWM dimming function. This example has two channels of constant current corresponding to different color temperatures, and can also be single-channel or multi-channel.

The voltage dividing resistors include a second resistor R2 and a fourth resistor R4, which are connected to the 50V output terminal of the constant voltage module 10. An analog voltage is obtained after voltage division by the second resistor R2 and the fourth resistor R4 and transmitted to PIN10 of the MCU. The MCU performs ADC sampling on the analog signal and multiplies it by the voltage division ratio of the second resistor R2 and the fourth resistor R4 to be capable of obtaining the output voltage Vo of the constant voltage module 10.

The operational amplifier chip U1 and its surrounding resistors form a non-inverting operational amplifier, which can amplify the input signal by 1 +R8/R11 times in the same direction. In this example, the eighth resistor R8 is 220K, and the eleventh resistor R11 is 22K, so the non-inverting operational amplifier amplifies by 11 times. The input terminal of the non-inverting operational amplifier is connected to the first resistor R1, and the first resistor is connected to the GND terminal of the constant voltage module 10. When current flows through the first resistor R1, a voltage difference is generated. The non-inverting operational amplifier amplifies this voltage difference by 11 times and provides it to the Pin9 pin of the MCU. The MCU performs ADC sampling on the analog signal to obtain a voltage, and then converts the voltage to obtain the output current Io of the constant current driving circuit 100. Thus, the output power of the constant voltage module 10 is obtained as Po=Io*Vo.

Generally, the components of the constant current driving circuit 100 are mass-produced according to specifications, with little overall error and little difference in overall efficiency. The overall input power can be inversely calculated by pre-testing the efficiency of other constant current driving circuits 100. The driver efficiency varies under different duty cycles, so it is necessary to pre-test the efficiency under different duty cycles and store the data in the MCU. In actual calculation, the MCU finds the corresponding efficiency value through the PWM duty cycle output by itself to derive the efficiency. First, m constant current driving circuits 100 can be selected, and then the duty cycle from 0 to 100% is divided into x parts. The larger the number of x, the more test data is needed, and the more accurate the final result is. Under different x PWM duty cycles, the efficiency values of m constant current driving circuits 100 are measured and the average value is taken. The x average efficiency values corresponding to the duty cycles are made into a data table and stored in the MCU. The MCU reads the efficiency value η by looking up the table according to the corresponding actual duty cycle, and then the actual input power of the driver is Pi=Po/η.

The circuit input power calculation method proposed in the present disclosure is different from the actual power detection, and there is a difference from the value detected by a power meter. Actual comparisons show that the error can be controlled within 5%. However, in power detection applications with low requirements, it has the characteristics of a simple circuit. The input power can be calculated only by detecting Vo and Io of the constant voltage module 10 and then looking up the table through the MCU to obtain the efficiency value, so the peripheral circuit is relatively simple.

In summary, the constant current driving circuit 100 of the present disclosure uses the operational amplifier detection module 40 which is provided to detect the output current of the constant voltage module 10 and transmit it to the control module 30. At the same time, the control module 30 detects the output current of the constant voltage module 10, and then calculates the input power of the constant current driving circuit 100 according to the efficiency value of the constant voltage module 10. The calculated input power has a small error compared with the actual input power, the overall circuit is relatively simple, and it has good economy and practicality.

The purpose of the present disclosure is to provide a constant current driving circuit and a lamp.

To achieve the above purpose, the present disclosure provides a constant current driving circuit, including:
a constant voltage module, configured to convert an external alternating current into a direct current with a constant voltage, where a first resistor is connected to a negative output terminal of the constant voltage module;
a constant current module, connected to the constant voltage module and configured to convert the direct current with the constant voltage into a direct current with a constant current;
an operational amplifier detection module, where input terminals of the operational amplifier detection module are connected to both ends of the first resistor and configured to detect a voltage of the first resistor; and
a control module, where the control module is connected to a positive output terminal of the constant voltage module to detect an output voltage of the constant voltage module, the control module is further connected to the operational amplifier detection module, and an output terminal of the control module is connected to the constant current module and configured to output a signal to the constant current module.

The operational amplifier detection module amplifies the detected voltage of the first resistor and outputs the amplified detected voltage to the control module, and the control module calculates an input power of the constant current driving circuit according to the detected output voltage of the constant voltage module and the amplified detected voltage of the first resistor.

As a further improvement of the present disclosure, the constant current module includes two voltage dividing resistors connected in series to the output terminal of the constant voltage module, an analog voltage is obtained after voltage division by the two voltage dividing resistors and transmitted to the control module, and the control module converts the analog voltage to obtain the output voltage of the constant voltage module.

As a further improvement of the present disclosure, the constant current module includes a warm light constant current module and a cold light constant current module connected in parallel, which are configured to supply power to a corresponding warm light LED load and a corresponding cold light LED load respectively.

As a further improvement of the present disclosure, the control module outputs two channels of PWM signals, the control module outputs a warm light PWM signal to the warm light constant current module and outputs a cold light PWM signal to the cold light constant current module.

As a further improvement of the present disclosure, the operational amplifier detection module includes an operational amplifier chip, an eleventh resistor, and an eighth resistor, where one end of the eleventh resistor is connected to the first resistor, another end of the eleventh resistor is connected to an input terminal of the operational amplifier chip, and an output terminal of the operational amplifier chip outputs a current to the control module by the eighth resistor.

As a further improvement of the present disclosure, the control module is an MCU controller, and the MCU controller includes an ADC, configured to convert analog signals into digital signals for calculation.

As a further improvement of the present disclosure, a data table is stored in the MCU controller, and the MCU controller determines a corresponding efficiency value of the constant voltage module by looking up the data table according to an actual duty cycle to calculate the input power of the constant current driving circuit.

As a further improvement of the present disclosure, the control module is an MCU controller, a flyback isolation architecture is used in the constant voltage module, and a Buck constant current architecture is used in the constant current module.

Another purpose of the present disclosure is to provide a circuit input power calculation method.

To achieve the above purpose, the present disclosure provides a circuit input power calculation method for calculating the power of the above-mentioned constant current driving circuit, including the following steps:
step S1: detecting and amplifying the voltage of the first resistor, and outputs the amplified voltage to the control module by the operational amplifier detection module;
step S2: converting the amplified voltage of the first resistor which is received to obtain an output current of the constant current driving circuit by the control module, and at the same time detecting the output voltage of the constant voltage module by the control module;
step S3: calculating an output power of the constant voltage module according to the output current of the constant current driving circuit and the output voltage of the constant voltage module by the control module; and
step S4: calculating the input power of the constant current driving circuit according to the output power of the constant voltage module by the control module.

As a further improvement of the present disclosure, a formula for calculating the input power of the constant voltage module in step S4 is as follows:

$$Pi = Po / η ;$$

Pi represents the input power of the constant voltage module, Po represents the output power of the constant voltage module, and η represents an efficiency of the constant voltage module.

Another purpose of the present disclosure is to provide a lamp including the above-mentioned constant current driving circuit.

To achieve the above purpose, the present disclosure provides a lamp including the above-mentioned constant current driving circuit.

As a further improvement of the present disclosure, the lamp includes two light source modules with different color temperatures, the light source modules are connected to the constant current driving circuit by four wires, LEDW+, LEDW−, LEDC+, and LEDC−, where LEDW+ and LEDC+ are common anodes on the constant current driving circuit and directly connected to the output terminal of the constant voltage module.

The beneficial effects of the present disclosure are: compared with the prior art, in the constant current driving circuit of the present disclosure, the operational amplifier detection module which is provided detects the output current of the constant voltage module and transmit it to the control module, and at the same time, the control module detects the output current of the constant voltage module, and then calculates the input power of the constant current driving circuit according to the efficiency value of the constant voltage module. The calculated input power has a small error compared with the actual input power, and the overall circuit is relatively simple and has good economy and practicality.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are only used to illustrate the technical solutions of the present disclosure and not to limit them. Although the present disclosure has been described in detail with reference to the examples, those of ordinary skill in the art should understand that the technical solutions of the present disclosure can be modified or equivalently replaced without departing from the spirit and scope of the technical solutions of the present disclosure.

1. A constant current driving circuit, comprising:
a constant voltage module, configured to convert an external alternating current into a direct current with a constant voltage, wherein a first resistor is connected to a negative output terminal of the constant voltage module;
a constant current module, connected to the constant voltage module and configured to convert the direct current with the constant voltage into a direct current with a constant current;
an operational amplifier detection module, wherein input terminals of the operational amplifier detection module are connected to both ends of the first resistor and configured to detect a voltage of the first resistor; and
a control module, wherein the control module is connected to a positive output terminal of the constant voltage module to detect an output voltage of the constant voltage module, the control module is further connected to the operational amplifier detection module, and an output terminal of the control module is connected to the constant current module and configured to output a signal to the constant current module; and
wherein the operational amplifier detection module amplifies the detected voltage of the first resistor and outputs the amplified detected voltage to the control module, and the control module calculates an input power of the constant current driving circuit according to the detected output voltage of the constant voltage module and the amplified detected voltage of the first resistor.

2. The constant current driving circuit according to claim 1, wherein the constant current module comprises two voltage dividing resistors connected in series to the positive output terminal of the constant voltage module, an analog voltage is obtained after voltage division by the two voltage dividing resistors and transmitted to the control module, and the control module converts the analog voltage to obtain the output voltage of the constant voltage module.

3. The constant current driving circuit according to claim 1, wherein the constant current module comprises a warm light constant current module and a cold light constant current module connected in parallel, which are configured to supply power to a corresponding warm light LED load and a corresponding cold light LED load.

4. The constant current driving circuit according to claim 3, wherein the control module outputs two channels of PWM signals, the control module outputs a warm light PWM signal to the warm light constant current module and outputs a cold light PWM signal to the cold light constant current module.

5. The constant current driving circuit according to claim 1, wherein the operational amplifier detection module comprises an operational amplifier chip, an eleventh resistor, and an eighth resistor, wherein one end of the eleventh resistor is connected to the first resistor, another end of the eleventh resistor is connected to an input terminal of the operational amplifier chip, and an output terminal of the operational amplifier chip outputs a current to the control module by the eighth resistor.

6. The constant current driving circuit according to claim 1, wherein the control module is an MCU controller, and the MCU controller comprises an ADC that is configured to convert analog signals into digital signals for calculation.

7. The constant current driving circuit according to claim 6, wherein a data table is stored in the MCU controller, and the MCU controller determines a corresponding efficiency value of the constant voltage module by looking up the data table according to an actual duty cycle to calculate the input power of the constant current driving circuit.

8. The constant current driving circuit according to claim 1, wherein the control module is an MCU controller, a flyback isolation architecture is used in the constant voltage module, and a Buck constant current architecture is used in the constant current module.

9. A circuit input power calculation method for calculating the input power of the constant current driving circuit according to claim 1, comprising the following steps:
detecting and amplifying the voltage of the first resistor, and outputs the amplified voltage to the control module by the operational amplifier detection module;
converting the amplified voltage of the first resistor which is received to obtain an output current of the constant current driving circuit by the control module, and at the same time detecting the output voltage of the constant voltage module by the control module;
calculating an output power of the constant voltage module according to the output current of the constant current driving circuit and the output voltage of the constant voltage module by the control module; and
calculating the input power of the constant current driving circuit according to the output power of the constant voltage module by the control module.

10. The circuit input power calculation method according to claim 9, wherein a formula for calculating the input power of the constant voltage module in step S4 is as follows:
$$Pi = Po / η ;$$
wherein Pi represents the input power of the constant voltage module (10), Po represents the output power of the constant voltage module (10), and η represents an efficiency of the constant voltage module (10).

11. A lamp, comprising a constant current driving circuit, wherein the constant current driving circuit comprise:
a constant voltage module, configured to convert an external alternating current into a direct current with a constant voltage, wherein a first resistor is connected to a negative output terminal of the constant voltage module;
a constant current module, connected to the constant voltage module and configured to convert the direct current with the constant voltage into a direct current with a constant current;
an operational amplifier detection module, wherein input terminals of the operational amplifier detection module are connected to both ends of the first resistor and configured to detect a voltage of the first resistor; and
a control module, wherein the control module is connected to a positive output terminal of the constant voltage module to detect an output voltage of the constant voltage module, the control module is further connected to the operational amplifier detection module, and an output terminal of the control module is connected to the constant current module and configured to output a signal to the constant current module; and
wherein the operational amplifier detection module amplifies the detected voltage of the first resistor and outputs the amplified detected voltage to the control module, and the control module calculates an input power of the constant current driving circuit according to the detected output voltage of the constant voltage module and the amplified detected voltage of the first resistor.

12. The lamp according to claim 11, further comprising two light source modules with different color temperatures, the light source modules are connected to the constant current driving circuit by four wires, LEDW+, LEDW−, LEDC+, and LEDC−, wherein LEDW+ and LEDC+ are common anodes on the constant current driving circuit and directly connected to the output terminal of the constant voltage module.

13. The lamp according to claim 11, wherein the constant current module comprises two voltage dividing resistors connected in series to the positive output terminal of the constant voltage module, an analog voltage is obtained after voltage division by the two voltage dividing resistors and transmitted to the control module, and the control module converts the analog voltage to obtain the output voltage of the constant voltage module.

14. The lamp according to claim 11, wherein the constant current module comprises a warm light constant current module and a cold light constant current module connected in parallel, which are configured to supply power to a corresponding warm light LED load and a corresponding cold light LED load.

15. The lamp according to claim 13, wherein the control module outputs two channels of PWM signals, the control module outputs a warm light PWM signal to the warm light constant current module and outputs a cold light PWM signal to the cold light constant current module.

16. The lamp according to claim 11, wherein the operational amplifier detection module comprises an operational amplifier chip, an eleventh resistor, and an eighth resistor, wherein one end of the eleventh resistor is connected to the first resistor, another end of the eleventh resistor is connected to an input terminal of the operational amplifier chip, and an output terminal of the operational amplifier chip outputs a current to the control module by the eighth resistor.

17. The lamp according to claim 11, wherein the control module is an MCU controller, and the MCU controller comprises an ADC that is configured to convert analog signals into digital signals for calculation.

18. The lamp according to claim 16, wherein a data table is stored in the MCU controller, and the MCU controller determines a corresponding efficiency value of the constant voltage module by looking up the data table according to an actual duty cycle to calculate the input power of the constant current driving circuit.

19. The lamp according to claim 11, wherein the control module is an MCU controller, a flyback isolation architecture is used in the constant voltage module, and a Buck constant current architecture is used in the constant current module.
